(19) United States
(12) Patent Application Publication
(10) Pub. No.: US 2014/0215495 A1
(43) Pub. Date: Jul. 31, 2014

(54) TASK-SPECIFIC APPLICATION MONITORING AND ANALYSIS

(71) Applicants: Matt Erich, Burlington, MA (US); John Gage, Norfolk, MA (US); Sean Kelly, Brookline, MA (US); Kuntal Sengupta, Winchester, MA (US); David M. T. Ting, Sudbury, MA (US); Kyle Vernest, Boston, MA (US); Jeffrey S. MacLellan, North Reading, MA (US)

(72) Inventors: Matt Erich, Burlington, MA (US); John Gage, Norfolk, MA (US); Sean Kelly, Brookline, MA (US); Kuntal Sengupta, Winchester, MA (US); David M. T. Ting, Sudbury, MA (US); Kyle Vernest, Boston, MA (US); Jeffrey S. MacLellan, North Reading, MA (US)

(21) Appl. No.: 14/164,824

(22) Filed: Jan. 27, 2014

Related U.S. Application Data
(60) Provisional application No. 61/756,909, filed on Jan. 25, 2013.

(51) Int. Cl. G06F 9/54

(52) U.S. Cl. CPC G06F 9/542
USPC 719/318

(57) ABSTRACT

User interactions with multiple applications executed on a computational device may be monitored by intercepting messages corresponding to application-level events and recording data associated with the events, including, e.g., contents of application screens presented when the events occurred. The screen contents may be used, based on comparison with task-specific screen-sequence patterns, to link sub-sequences of the events to tasks, facilitating subsequent task-related analysis.

### CROSS-REFERENCE TO RELATED APPLICATIONS

This application claims priority to and the benefit of, and incorporates herein by reference in its entirety, U.S. Provisional Patent Application No. 61/756,909, filed Jan. 25, 2013.

### TECHNICAL FIELD

The invention relates generally to data analytics, and in particular to systems and methods for monitoring usage of computer applications.

### BACKGROUND

Increasingly, businesses and institutions rely on a broad suite of data-driven computer applications to keep track of critical processes, workflow, and people. Often, these applications interact with large databases, and although the same data may be relevant to (and accessed by) multiple applications, these often operate independently and, indeed, may be supplied by different providers. Perhaps nowhere is this more true—and problematic—than in the healthcare world. Medical institutions from hospitals to physician practice groups to testing centers maintain diverse electronic medical records (EMR) systems, which collectively form the healthcare information backbone. EMR systems allow clinicians access to medical information maintained in various back-end systems. The typical workflow when a physician interacts with a patient involves first logging onto the computer system, then launching and logging into one or more EMR applications, selecting the right patient record, verifying that the record matches the patient, reviewing results (often from different sources), checking up on medical references, entering orders or prescriptions (e.g., using computerized physician order entry (CPOE) applications and ePrescribing), and/or charting patient progress. All of these activities may involve different applications, and in some cases multiple separate applications for a single activity.

As healthcare institutions face increasing economic pressure to do more with less, they have turned to data analytics to identify opportunities for efficiency improvements. These efforts range from identifying patients likely to generate high costs to improving clinical productivity by streamlining workflows and reducing the “friction” between users and computers. The clinical applications used by physicians and staff provide a rich source of data for analysis, but because of their disparate and unconnected nature, extracting relevant data in an unobtrusive manner and without application-specific programming efforts can prove difficult as a practical matter. Accordingly, there is a need for approaches to monitoring multiple computer applications in an integrated manner and drawing meaningful information therefrom without disrupting application usage.

### SUMMARY

The present invention provides, in various embodiments, systems and methods for recording sequences of application-level events (such as, e.g., mouse clicks or screen changes) that take place during usage of one or more user applications, and linking subsequences of these events to tasks that are meaningfully defined in the application context. In this way, how one or more applications are used can be evaluated relative to the tasks being performed. For instance, in a healthcare context, a sequence of interactions by a physician with one or more EMR applications may be associated with performing tasks such as, e.g., reviewing lab results, charting patient progress, and issuing a drug prescription. In various embodiments, the task associated with a recorded event sequence may be inferred based on stored patterns of known screen sequences associated with corresponding tasks, employing, for example, screen-recognition logic to identify individual screens associated with the recorded events. Once identified, the tasks can inform subsequent data gathering, filtering, and analysis. For example, the efficiency of alternative applications can be compared based on the number of events (or the amount of time) associated with performance of important or frequently executed tasks, while the efficiency of a user can likewise be gauged based on the number of events logged during the performance of a task relative to the number logged by other users performing the same task with the same application(s). In the former case, efficiency analysis can help select among available applications, and in the latter case, user efficiency can be improved through additional user training.

As used herein, an “application-level event” (hereinafter simply “event”) means a discrete action or occurrence that can be detected and handled by the application; events include, for example, user interactions with the system (such as mouse clicks, keystrokes, window-resizing, data entry, etc.) and messages from other applications or hardware devices (such as commands to open or close a window). Recording events in accordance with various embodiments generally involves storing screen contents displayed when the event occurs (e.g., in the form of image files or, more typically, at the source-code level). Alternatively or additionally, event may be recorded by storing event identifiers in a database record created for a current task, or in any other suitable format that captures and preserves the information that will subsequently be used for analytic purposes. Screen contents may include both static contents (i.e., the screen portions that are programmatically defined and do not change as a result of user interactions) and dynamic contents (i.e., those portions which reflect input from the user and/or other applications, such as entered text or imported data). Considering only static contents, each application typically generates a finite number of screens; these screens, or the characteristic elements thereof, may be stored in a database of reference screens (set up, e.g., by a system administrator or informaticist), allowing event screens to be identified based on matches with the reference screens. See, e.g., U.S. Pat. No. 7,941,849, the entire disclosure of which is hereby incorporated by reference.

Performance of a specific task (using a computer) typically involves navigating a particular sequence of screens (allowing for variants and some deviation), within a single application or across applications, and interacting with these screens in a particular manner. Thus, tasks can generally be associated with patterns of screen sequences. A “pattern,” as used in this context, specifies sufficient information about a screen sequence—e.g., screen types, the order in which they are accessed, and possibly certain dynamic contents included therein—to infer performance of a task; that is, the recognized pattern is associated with a particular task to a high degree of confidence. Depending on the task at hand, patterns may define a task-specific sequence more tightly or more loosely, ranging anywhere from completely specifying the exact order of screens (as defined by their static contents) to providing a large set of alternative navigation paths involving screens with more or less similar (static or dynamic) contents across the alternatives. In many cases, a task can be accomplished using different screen sequences (which may be permutations or combinations of a number of screens) that may, for example, all lead up to a particular task-specific final screen. For example, a physician entering an order may obtain the requisite patient and/or other information from multiple sources and enter data for the order in any of various forms, but may ultimately need to reach a particular submission screen to place the order. In such cases, the task can be inferred from a “loose” pattern of identified screens including, for example, the final screen and one or two characteristic intermediate screens displayed in a characteristic order. Thus, it may not be necessary to store all possible screen sequences associated with a task and to incur the combinatorial cost of comparing all of these to a current sequence in order to infer the current task.

Linking screen-sequence patterns to tasks in this manner facilitates extracting meaningful task-level information from a sequence of recorded events. In general, the events within a chronological record need not all pertain to the same task. Sometimes, a user performs multiple tasks in an alternating or interleaved fashion. For instance, a healthcare provider may monitor and document the conditions of multiple patients throughout the day, and monitoring different patients may correspond to separate tasks of interest. Events corresponding to the same task may be tied together based on a common screen element, such as a patient ID. Further, task execution may occasionally be interrupted, either by another task of superseding priority or by events irrelevant to tasks of interest. For instance, in between monitoring patients, the healthcare provider may check her personal email account, and data about events recorded during this disruption may later be discarded. (Of course, for audit purposes, the time the provider spends on private matters may in itself be of interest, in which case such activities may be defined as recognizable “tasks.”) Similarly, certain generic activities, like logging into the computer system, may fall outside the scope of a defined task or constitute tasks in their own right, as the case may be. Thus, tasks in accordance herewith may generally be defined in any suitable manner, depending on the purpose and goal of monitoring application usage in the particular circumstance. Importantly, a task need not be limited to usage of a single application, but may involve application screens across multiple applications. Conversely, usage of a particular application screen need not be confined to a single task, but may occur in multiple different tasks. However a task is defined, its performance may be inferred from a recorded sequence of events if a subsequence of events matching a task-specific screen-sequence pattern is detected within the larger sequence. A “subsequence,” as understood herein, is a list of a subset of the events of the larger sequence in which the relative order between events is retained from the larger sequence. The subsequence includes at least two, and in the extreme case all, of the events of the originally recorded sequence of events.

Task recognition based on screen sequences allows filtering, sorting, parsing, or otherwise organizing data associated with a sequence of monitored events, as well as performing task-specific analyses. For example, in response to input (e.g., by a user or system administrator) regarding one or more tasks of interest, data about events not pertaining to any of these tasks may be discarded. In addition, the data associated with task-relevant events may be filtered and/or processed to retain only those items of information that affect the analysis of the task-specific data, e.g., that are used in the computation of a specified metric of interest. For instance, in evaluating the efficiency with which certain tasks are performed, metrics that may be of interest include the duration for which screens are active, the number of screens traversed in performance of the task, and the number of transitions between different screens and applications. By contrast, for purposes of auditing the care that a patient receives, prescription data, treatment details, and observations made and entered by the treating physician or attending nurse may be more relevant.

In various embodiments, the capability described above is provided by a software observer “agent”—i.e., an application typically running as a background process on a computing device—in conjunction with databases for the reference screens and task-related screen-sequence patterns. The observer agent may monitor application usage by “hooking” into the message queues for the various active applications; basic application-hooking technology is routinely provided by the WINDOWS operating system, for example, and is well-known in the art. Typically, the agents injects a separate “hook” into each application, which tracks the events taking place in that application by intercepting, in a non-intrusive way, messages passed between the application and other user applications, the operating system, and/or user interface objects (such as buttons, menus, text fields, etc. that are defined at an intermediate level between the operating system and the applications). Data associated with each event, such as the time, type of event (as discerned from the message content), and contents of the active screen, are recorded in a memory queue for the application. The observer agent then reads out the memory queues, generally asynchronously, and aggregates the event data from multiple applications in a single journal file, thereby generating a comprehensive timeline of the user's interactions with all monitored applications during a user session. By comparing the recorded screen contents against the reference screens and matching subsequences of screens against the task-specific screen-sequence patterns, the observer agent, or an analysis engine operating subsequently on the journal file, may filter the data to extract information relevant to one or more tasks of interest.

In some embodiments, information about application usage is gathered and/or analyzed across multiple users, multiple computing devices, and/or even multiple networks. (A “computing device,” as understood herein, broadly connotes computers, tablets, “smart phones,” personal digital assistants, and any other device used in performance of a task of interest and amenable to monitoring as described herein.) For instance, the journal files for all user sessions from all devices used within an organization (such as a hospital) may be uploaded to a central analysis server capable of analyzing and, in some cases, discovering the relationships between time, user, device, task, application, application screens, application controls, user input, etc. The accumulated historical data stored in the database facilitate comparisons between different users and devices, as well as averaging across users and devices to obtain a broader data basis for discovering statistical relationships between different sets of variables—for example, to determine whether the total time needed to perform a set of tasks depends on the order in which they are executed. These relationships potentially provide opportunities for improving efficiencies in the workflow and resource allocation of the organization. Data may, moreover, be shared among different organizations to enrich the pool of historical data, facilitate comparative analysis, and identify best practices.

While the foregoing and ensuing discussions focus, for purposes of illustration, on healthcare applications and tasks, it should be understood that the invention is not limited in this manner, but may be applied to virtually any field involving identifiable tasks performed with software applications, and where task-related analytics are of value.

In one aspect, . . .

### BRIEF DESCRIPTION OF THE DRAWINGS

The foregoing will be more readily understood from the following detailed description, in particular when taken in conjunction with the drawings, in which:

FIGS. 1A and 1B are block diagrams illustrating an exemplary system for task-specific application monitoring in accordance with various embodiments; and

FIG. 2 is a flow chart illustrating a methods for task-specific application monitoring in accordance with various embodiments.

### DETAILED DESCRIPTION

Various embodiments of the present invention relate to monitoring usage of software applications, in particular, in computer-network environments where the same applications are executed or accessed on multiple workstations and/or employed by multiple users. For example, in a hospital, a local computer network may provide authorized users (including, e.g., doctors, nurses, and/or other healthcare providers employed by the hospital) access to a suite of EMR and related applications at any of the workstations (i.e., client devices) within the network. The workstations may be desktop or laptop computers, thin-client devices that provide access to applications remotely executed on a server, tablets, smartphones, or other types of computing devices. Tracking application usage at each workstation in accordance with methods disclosed herein, and aggregating the information across workstations and/or across users, can provide a wealth of information—useful, for instance, for audit purposes or analyses geared towards efficiency improvements—about workflows, performance of various tasks (whether computer usage is central or merely incidental thereto), and the way users interact with the applications.

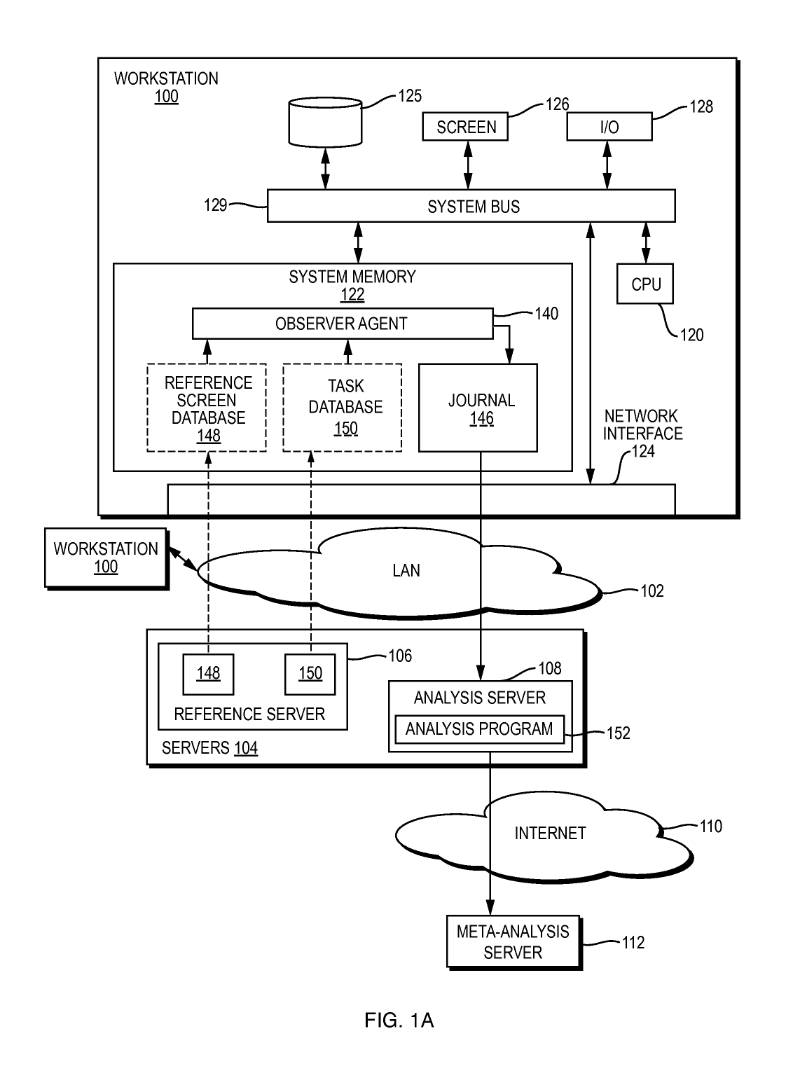

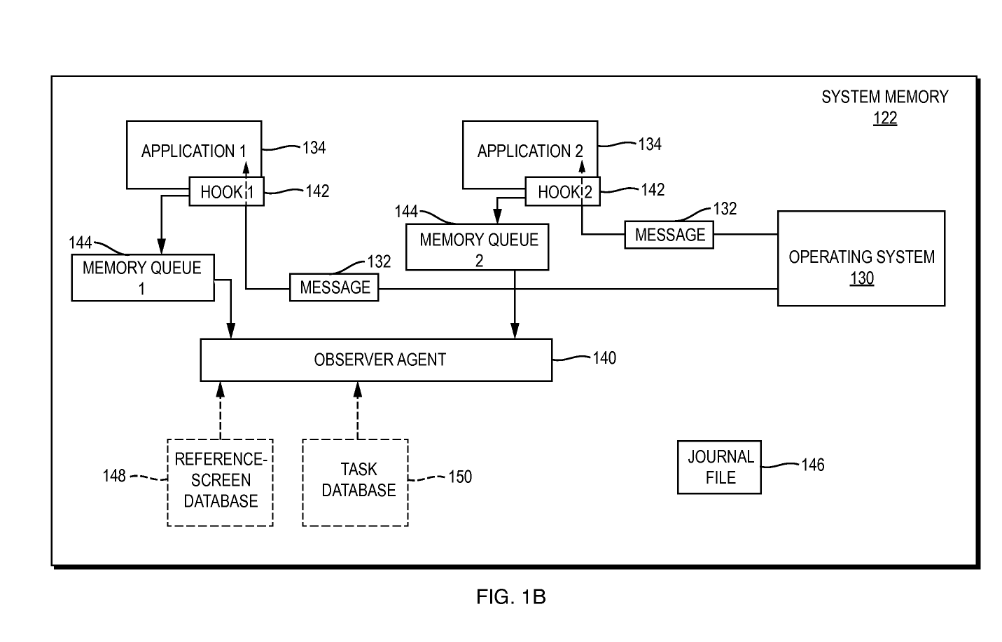

FIGS. 1A and 1B illustrate an exemplary system with application-monitoring capabilities in accordance herewith. As shown in FIG. 1A, the system includes a plurality of workstations 100 connected, via a suitable wired or wireless network 102, to one or more servers 104. The network may, e.g., be the hospital's (or other organization's) intranet, and may be implemented as a local-area network (using, e.g., Ethernet or Wi-Fi technology). In a hospital context, the server(s) 104 may include, for instance, an authentication server that checks user's authentication credentials upon login to the system, a central data server (or group of servers) hosting the EMR databases, and/or one or more remote application-hosting servers. In embodiments hereof, the server(s) 104 may further include an analysis server 106 for gathering and analyzing application-usage data and, on the same or a separate computer, a reference server 108 storing screen-reference and task-pattern databases. The local network 102 may be connected, in turn, to a larger network 110, such as a wide-area network or the Internet, allowing communications, e.g., between the analysis server 106 and a meta-analysis server 112 outside the hospital network, as explained further below.

The workstation 100 may, e.g., be a general-purpose personal computer (running suitable software), and typically includes a processor 120 (e.g., a CPU) and associated system memory 122, a network interface 124 (for connection to the network 102 and/or the Internet 110), and, usually, one or more non-volatile digital storage media 125 (such as a hard disk, CD, DVD, USB memory key, etc.) and associated drives. Further, the workstation 100 includes user input/output devices such as a display screen 126, conventional tactile input devices 128 such as keyboard and mouse or touch pad, and optionally microphone and speaker, cameras (e.g., for user authentication and detection of walk-away events), etc. The various components communicate with each other via one or more buses 130.

In use, the processor 120 executes one or more computer programs (herein conceptually illustrated as program modules) stored in the system memory 122. Referring to FIG. 1B, an operating system 130 (such as, e.g., MICROSOFT WINDOWS, UNIX, LINUX, iOS, or ANDROID) provides low-level system functions, such as file management, resource allocation, and routing of messages 132 from and to the hardware devices (such as the user input/output devices 126, 128) and one or more higher-level user applications 134 (such as EMR applications, office programs, a web browser, etc.). The user interacts with the application(s) 134 by providing input via the input devices, e.g., by typing on the keyboard, moving the mouse, or clicking with the mouse on a displayed control element such as a scroll bar. In a WINDOWS system, for each such input event, a message 132 is created (e.g., by the device driver of the input device). Messages 132 may also be created by and/or in response to applications 134; for example, an application 134 may send a message containing an output to be displayed on the screen 126, or effect a system-level change such as a change to the pool of system font resources or window resizing. The MICROSOFT WINDOWS operating system passes all application-related inputs in the form of messages 132 to the window(s) in which the application 134 operates; each message 132 may, for this purpose, include a window handle specifying the destination application or window. The message 132 may further include a message identifier that tells a so-called window procedure of the destination window how to process the message, as well as one or more message parameters containing relevant data (or a pointer thereto) used during such processing. Each message 132, depending on its type, is either sent directly to the windows procedure, or temporarily stored in a message queue for the destination application or window for subsequent retrieval therefrom by the window procedure.

To facilitate monitoring how a user interacts with the application(s) 134 over an extended time interval, the workstation 100 may include a software observer agent 140 that runs, typically, as a background process (i.e., invisibly to the user) on the desktop operating system 130. The observer agent 140 may be implemented as an application that is started like any other application but does not create a user interface, or as a system service that is started automatically upon boot-up of the workstation 100, and typically has knowledge of which user is authenticated to the workstation 100. The agent 140 gains visibility into the events the application(s) 134 are expected to handle, e.g., by hooking into the message queues for different applications 134. As shown, the agent 140 may generate, for each monitored application 134, a separate “hook” 142 operating within the context and address space of that application. The hook 142 non-intrusively intercepts messages 132 (corresponding to events) received by any window associated with the hooked application, and logs the corresponding events in a memory queue 144. The observer agent 140 may subsequently, e.g., when the application 134 is idle, read out the memory queue 144; this arrangement minimizes performance impacts on the user. Application-hooking technology that, in this manner, allows an external application such as the observer agent 140 to be injected into another application to monitor messages passed between that application and the operating system is routinely provided by, e.g., the WINDOWS operating system, where it ordinarily serves debugging, shadowing, training, and similar functions.

When de-queuing the memory queues 144, the observer agent 140 may transfer event-related data from the memory queues 144 of multiple applications 134 to a single journal file 146, thereby aggregating data across the applications 134 to generate a comprehensive timeline of the user session. In accordance with various embodiments, the data for each event may include, in addition to the time of the event and a suitable event identifier (which specifies the kind of input that the application received (and/or, in some embodiments, the kind of output it generated) and may be inferred, e.g., from the message identifier), information about the contents of the application screen that was active at the time of the event (i.e., the display content of the active application window, which may, but need not, cover the entire screen 128). Such screen contents are stored, by the hooks 142, in the memory queues 144, e.g., in the form of image data (e.g., compressed or uncompressed bitmaps) or, preferably, in the form of program code (e.g., source code) or some other form that allows, in principle, reconstruction of the application screen (or portions thereof) In various embodiments, the static and dynamic textual content and the type of controls (e.g., text input, buttons, title bar, etc.) are extracted and stored.

The observer agent 140 may compare the event-related screen data against a database 148 of reference screens, i.e., identification data for individual screens (including the entire screen contents or portions thereof), which may be structured, e.g., within a declarative XML document. The reference-screen database 148 may be centrally stored on the reference server 108 and then downloaded to different workstations 100 when the respective observer agent 140 starts up, e.g., following user log-on. Alternatively, the database 148 may be stored on permanent storage media 125 within the workstation 100. For efficient access, the database 148 is typically (but not necessarily) loaded into the workstation's system memory 122 in its entirety upon launch of the observer agent 140. Based on comparisons of the event-related screen data with the reference screens, the agent 140 may filter screens and/or identify types of screens, e.g., for subsequent recognition of certain screen-sequence patterns, as described further below. The observation agent may also be configured to discriminate, e.g., based on the event identifiers, between generic, low-level events (such as, e.g., window-active, window-focus, window-resize events and other events generated by the operating system to indicate that the screen is active) and “significant” events that warrant screen comparison; in other words, the agent may perform an initial coarse filtering before primary filtering by comparing the information on the screen against the reference set of screens in the database 148.

The reference-screen database 148 may be generated in a learning phase during set-up of the system (i.e., prior to run-time deployment of the observer agent 140); this learning phase may itself be automated or rely on active user input. In some embodiments, a system administrator, informaticist, end user (e.g., clinician), or other competent person tags (e.g., using a pointing device such as a mouse) different application screens and, for each tagged screen, either manually specifies characteristic, recognizable information that can be used for subsequent differentiation of screens, or instructs a program routine (which may be implemented, e.g., in the observer agent 140) to find such information. In other embodiments, screen elements suitable for recognition purposes may be identified automatically without user prompting, e.g., by screen-to-screen comparisons that reveal the distinctions between screens (and ignore screen elements generic to many screens). The characteristic information for each screen, which may be a combination of process names, control types (such as radio buttons, text-entry fields, drop-down menus ,etc.), control hierarchies, and displayed text or labels, is stored in the database 148 in association with a suitable screen identifier (e.g., a unique screen name entered by the user or an automatically assigned number). The administrator or user may also assign a label for each screen to indicate its purpose, i.e., the cluster of tasks it supports or a higher-level designation meaningful for later analysis (e.g., “patient history” or “ePrescribing”); this label may be used as part of the screen identifier, or stored along with the screen identifier and other screen information.

For some screens, the entire screen contents (i.e., corresponding to all pixels of the active window) are saved, again either in image format or in programmatic form (e.g., XML or as a hierarchical tree in which each node of the tree represents a visual object (such as a button or other control) nested within a parent frame or container). For other screens, only certain portions, such as text, information about user controls, or other low-bandwidth screen elements, are stored if sufficient to support screen recognition. The reference-screen database 148 may also specify screen portions that capture dynamic contents (e.g., text portions that show the user name or a patient identifier, or text entry fields) which may be useful in screen-based event analysis. The amount and character of the information saved in the database 148 to facilitate recognition generally depends on the screen, and may be determined heuristically (based, e.g., on the type of application, the contents of the screen, and/or the usage context and type of analysis to be performed) or may be specified by the user on a screen-by-screen or application-by-application basis (e.g., when labeling a screen).

At runtime, the observer agent 140, employing suitable screen-recognition logic, compares the screen contents associated with the tracked events that it retrieves from the memory queues 144 against the screens in the screen-reference database 148, thereby identifying relevant event screens. This capability allows associating, with sequences of events recorded in the journal file 146, corresponding sequences of application screens. Such screen sequences, in turn, may facilitate recognizing the types of tasks that were performed by the recorded series of events. A screen sequence, as used herein, includes at least two screens. The screens may differ in their static contents and, thus, map onto different reference screens in the database 148. However, a sequence may also include or consist of multiple screens corresponding to the same reference screen, but varying in their dynamic contents. An application may, for instance, facilitate performing a certain task within a single (as far as its static content is concerned) application screen, which is populated with data (e.g., entered by the user) in multiple steps; the dynamically changing screen contents correspond to a sequence of screens as used herein. Task-specific screen-sequences, or screen-sequence patterns, may be stored in a task database 150 Like the reference-screen database 148, the task database 150 may be stored on the reference server 108 (as shown) or on permanent storage media 125 of the workstation 100, and may be loaded into system memory 122 at runtime.

The task database 150 may be created in its entirety, or at least initialized, when the system is set up. For example, for a suite of clinical software applications, a clinician familiar therewith may specify, a priori, which screen sequences (or sequences) are generally traversed in performance of certain clinical tasks. The task-specific screen-sequence pattern may specify the type and order of screens completely for one or more sequence(s); specify only the types of screens while allowing permutations of at least a subset of the screens (e.g., if the exact order of steps is not critical to execution of the task); list multiple alternative screens for certain positions within the sequence (e.g., if certain steps of the task can be accomplished by any one of multiple applications) or list sets of screens a combination (i.e., generally, subset) of which may be traversed in performance of the task; or even specify only certain task-critical screens (e.g., corresponding to boundary events marking the onset and/or completion of the task) while leaving other screens within the sequence open. A screen sequence for prescription of a drug, for instance, may be specified by a patient-selection screen, a drug-selection screen, and, as the final screen, an order-submission screen; additional screens, such as one or more drug-search screens that enable identifying treatment options based on user-entered clinical symptoms or diagnoses, may or may not be used in a particular instance of performing this task.

Alternatively or in addition to specifying screen-sequence patterns manually based on a-priori knowledge, task-specific patterns may also be discerned from an ensemble of recorded screen-sequences using, e.g., a machine learning approach. For example, with the observer agent 140 and reference-screen database 148 in place, users' interactions with the applications of interest may be monitored and recorded over a period of time sufficient to gather a sizable amount of data covering preferably multiple instances of the performance of each task. The data may be fed as training data into a suitable machine-learning algorithm, which may then group the recorded screen sequences based on similarities therebetween. For example, treating the different application screens as a set of nodes and transitions between the screens as edges between the nodes, the resulting graph may be analyzed for paths (i.e., sequences of edges connecting an ordered sequences of nodes) that share certain nodes using, e.g., a graph-matching algorithm; suitable algorithms are well-known to those of skill in the art (e.g., of graph theory). Groups of similar screen sequences may then be presented to a user for labeling them with a corresponding task, or the task may be inferred automatically, e.g., based on screen contents that occur in all or most of the sequences within the group (such as text indicative of the task, like “patient vitals” or “prescription”). Tasks may also be identified by the user prior to or during her performance thereof; the recorded screen sequence can, in this case, be labeled with the task at the outset, and a pattern-recognition algorithm may analyze screen sequences that share the same task label to extract the commonalities therebetween and define the pattern based thereon. In all of these embodiments utilizing empirical data about the screens that the user navigates when performing certain tasks, the task database 150 may be updated and enhanced during and based on system usage, either continuously or in intervals.

Access to the reference-screen and task databases 148, 150 allows the observer agent 140 to identify the type and purpose of event-related screens based on its contents, link recorded events to specific tasks, and perform task-specific filtering of events and the data associated therewith. For example, given a list of tasks of interest (specified, e.g., by an administrator or informaticist during system set-up or at a later time, or by a user at the beginning of her session), the agent 140 may determine which of the event records read out from the memory queues 144 of the various applications pertain to any of these tasks, and transfer only those which do to the journal file 146 for more permanent recording. In some instances, individual event records can be filtered out and discarded based on the absence of their associated application screens from any of the task-specific screen sequences of interest. In other cases, individual events may match one or more task-specific sequences, but the task to which a particular sub-sequence of recorded events belongs (if it belongs to any at all) does not become apparent until a few screens have been processed; if it turns out, in such a case, that the recorded events are not of interest, they may be deleted from the journal file 146.

For events that are retained in the journal 146, the associated data, and the screen contents in particular, may be filtered to retain only types of information relevant to the task and/or the type of analysis for which the data is collected (as specified, e.g., by the system administrator for all users or individual users or user groups), or which is deemed important for other reasons (e.g., because the user, such as a physician, so indicated at the beginning of his session). For example, in some embodiments, the hooks into the different applications store the contents of the active screens in their entireties; upon matching the screen contents against the reference screens, however, the static screen-content portions may be discarded in favor of a simple screen identifier, and the dynamic screen contents and/or other event data (such as the event identifier and time) may be stored along with the screen identifier in the journal file 144. Further, for certain types of analyses, the screen contents may not have any relevance beyond their use to ascertain tasks. For example, to evaluate the efficiency of task performance, it may suffice to count the number of screens accessed from start to completion of the task, or compute the time elapsed based on the time stamps associated with the first and last screens in the task-specific sequence. In some embodiments, the types of data that are to be retained are specified in database entries associated with the reference screens and/or the task-specific screen-sequence patterns. Furthermore, the observer agent 140 may implement filtering rules that take, e.g., the type of the recorded event into account. For instance, for a mouse-click event, it may suffice to store the control element or screen portion (or simply screen location) onto which the user clicked.

To distinguish between different instances of the same type of task (which may be executed in an alternating or interleaved fashion), or link different tasks to each other based on a common attribute, the observer agent 140 may store a dynamic screen element that is shared among all screens belonging to the same task instance. In a medical context, for example, it may be useful to record the displayed patient medical record number (MRN) or patient name from the title (or other control) of each screen to allow data to be sorted based on the accessed patient records. To protect patient privacy, the observation agent may “de-identify” the entry so that the patient's name or MRN is not exposed; for example, the observer agent 140 may generate a forward hash for any patient identifier, which may thereafter be used to link event records for the same patient without exposing the patient's real name. Workflow comparisons across different EMR sessions using the hashed patient identifier, for example, can reveal how many times different clinicians interacted with a particular patient's records, for how long and with what applications, which computer(s) they used to access the information, etc. Similar de-identification techniques may also be used to de-identify the user (whose login name may be displayed on the application screens), e.g., to allow different healthcare institutions to upload data for anonymous comparisons with peer institutions.

Although detailed event analysis usually occurs at a later stage, the observer agent may also perform certain computationally straightforward operations on the journaled events and event sequences maintained for each user within separate log-on sessions. In particular, the ability to correlate observations made over a period of time facilitates generation of more complex time-based events. The responsiveness an EMR application, for example, can be computed from the elapsed time from the last user-entry event to the time of the next screen update message—that is, a “response time” event is created from two directly observed “primitive” events. The amount of data input while the screen was active (has focus) may also represent a complex event of interest, and requires tracking when the control first became enabled. Other complex events that can be computed or generated (as opposed to merely recorded) may include, for example, the amount of time spent typing (and the average typing speed) within a control and/or how far the user moved the mouse within a screen (indicating the amount of hunting/clicking activity). The observer agent may also be able to track when an alert or warning dialog is generated by the application to determine how “busy or noisy” the application is, and whether a particular function is more difficult to use as evidenced by the higher percentage of warnings per screen.

In various embodiments, the observer agent 140 generates a separate journal file 144 for each user session. The journal files 144 from generally multiple computing devices (e.g., all of the workstations 100 within the organization) may be uploaded (individually upon completion or aggregated for multiple user sessions at certain time intervals) to a central analysis server 106. (Alternatively, the observer agent 140 on a particular machine may track all user interactions thereat indefinitely, without regard to user sessions, and store them in a single journal file 144 (e.g., storing a user identifier or de-identified user tag along with each event to enable subsequent sorting of the data based on the user), and the records in the journal file 144 may be periodically backed up or transferred to the analysis server 106.) From the aggregate data, the analysis server 106, via one or more suitable analysis programs 152 executed thereon, may generate statistics over time and across users and/or machines to determine, for example, the average time a clinician spends on each screen before navigating to the next screen, the average amount of user input entered on each screen (e.g., via mouse and/or keyboard), the average number of transitions that take place within an application, the typical screen sequence between applications, etc.

The accumulated historical data may also serve to perform comparisons between users and/or between machines or, more generally, to discover relationships between time, clinician, workstation, patient, task, application screen, application controls, user input, and/or other variables. The data may, for example, be mined to determine whether the total time for two tasks (e.g., charting patient progress and prescribing a therapy) is smaller when the tasks are executed back-to-back or in an interleaved fashion, or whether differences between the time required by different users for certain tasks correlate with different applications employed for these tasks. These kinds of relationships potentially provide opportunities for improving efficiencies in the (e.g., clinical workflow), computer resource allocation, application licensing, etc. For example, if one application requires a significantly smaller amount of user input than another with substantially the same results (e.g., by automatically importing data where appropriate), the first application may be recommended to users (and/or the second deleted from the system). Or, if users routinely access more screens than necessary to accomplish a certain task, they may be trained in more efficient ways to navigate the application(s), and/or inefficient paths with excess screens may be precluded by means of modifications to the software design. As yet another example, if it turns out that a particular application is used only on some machines and not others, or is used by only a limited number of users simultaneously, such information may allow purchasing fewer licenses to the application.

In some embodiments, the records and data stored on the analysis server 106 within the institution (i.e., located in or operated by or on behalf of the institution that employs the workstation's user) are further uploaded to a meta-analysis server 112 for statistical analyses across and/or comparative analyses between institutions. Prior to uploading, the data may be de-identified, e.g., by parameterization (i.e., selective mapping of relevant dynamic data with hashed or random data that obscures the true value but allows them still to be correlated) or at least replacing identifying information (such as a hospital name or a clinician's name) with neutral designations, such that the observations rendered are anonymous. The data may be send, e.g., in the form of an XML document that de-identifies the institution generating the information, but contains statistically relevant data such as the type of facility, number of beds, etc. The meta-analysis server 112 allows a hospital, for example, to gauge its performance against a set of comparable peers. Detailed observations made for a particular (e.g., EMR) application can also provide analytic feedback to the vendor on how users interact with its software, facilitating improvements to the user interface.

In some embodiments, the information from the journal files 144 uploaded to the analysis server (and/or the meta-analysis server 112) is organized thereon as a relation database, which facilitates rapid retrieval and access using, e.g., SQL queries. Different relational tables may be used to organize the information according to important relationships among data types. Each table may maintain a structure with multiple fields containing relevant information either directly collected or computed from journaled events. In addition, fields may contain “foreign keys” that link one type of record with another (such as a record for a log-on session with links to records for the machine and the user). Tables may be maintained, e.g., for machines (specifying the PC or hosted machine being used); users (specifying the users logged on to a machine); log-on sessions (defining the start/end times associated with each successful user log-on attempt); log-on attempts (defining the specifics of each successful/unsuccessful log-on attempt leading up to a successful user log-on session); application sessions (defines specifics associated with each successful user log-on attempt within a session); application log-on attempts (defining the specifics of each success/unsuccessful authentication attempt associated with an application); application screens (defining the start/end times when a screen within an application session is considered active); application control contents (defines content captured from controls within a specific screen); application alerts (specifying contents from alert dialogs generated by interactions with a specific screen); application authentication attempts (defining the specifics of each authentication request generated by an application screen); application control input (defining the specifics for user inputs (mouse, keyboard) entered into different application controls within application screens; patients (specifying the de-identified patient IDs encountered within different application screens); and/or tasks (defining the specific sequences of screens within either an application session or a log-on session corresponding to a pre-defined screen sequence).

Journaled data stored in the relational database on the analysis server 108 (or meta-analysis server 112) may be retrieved along different dimensions to reconstitute different “views” (as term is used in the art of databases) of how the system is being used. The process of generating views may involve following links from one record to another to build a transient table that facilitates calculation of statistical data. A table that specifies which clinicians have interacted with a specific patient, for example, is built by finding all screens with the same patient ID (which may be de-identified), identifying application sessions corresponding to the screens, and, from the application sessions, inferring the log-on sessions and obtaining the clinician log-on info stored in the respective table. The resulting table is then sorted by time to build a timeline for all EMR interactions with the patient.

Views that may be useful include, for example: a computer view (showing how long and by whom different computers are used, the number and type of applications running on each computer, etc.); a system log-in view (capturing information about the user's login experience, such as the number of characters entered or the time elapsed during login); a user (e.g., clinician) view (including information on how EMR or other applications are used by various clinicians); and a patient view (specifying, e.g., the computer and applications used, and the tasks performed, in the care of particular patients). Further, embodiments hereof enable generation of task views, which provide information on the types of tasks performed (as obtained from the sequence of screens observed within each user session), such as the type of task performed, the number of times it was performed, total elapsed time for each performance, the amount of user input entered for the task (e.g., number of characters entered, number of mouse clicks, mouse distance travelled, average typing speed for text-field entries), the sequence of screens involved in a task (as well as, for each screen in the sequence, the dwell time on the screen, and/or the response time from a control event to a corresponding change on the screen display), and/or the sequence of screens launched by the user within different sessions. Another important view may be an application view showing information on how long, by whom, and where different applications have been used, such as the set of applications launched by different users, the sequence of applications touched by users during a session, the average memory use and CPU load consumed by each application, the number of forms or screens accessed within each application, the length of time user spends on each screen, the length of time spent on each application, the transition times from one screen to another, the number of warning alerts generated by various screens, the mount of user input entered for each screen, application and transaction authentication requests for each application, etc.

In various embodiments, targeted queries to and/or suitable views generated from the relational databases stored on the analysis server 108 (or the meta-analysis server 112 or, in some instances, the original journal file 144 stored on the workstation 100) are used to compute one or more task-specific metrics of interest. A “task,” for this purpose, may be one of the individual, or “atomic” tasks defined in the task database 150 and recognizable from an associated screen-sequence pattern, or a “super-task” involving a combination of such individual tasks (including, e.g., well-defined “super-sequences” of atomic tasks, multiple instances of a particular atomic task, or collections of atomic tasks identified based on a set of filtering criteria). For example, a task of interest may be the care that a particular patient receives from all healthcare providers throughout a particular day, week, or month; information about this super-task can be obtained from the database by retrieving all records within the specified time frame that match the relevant patient ID (the time frame and patient being the filtering criteria), and generally includes a plurality of individual tasks of different types (e.g., taking the patient's vitals, conducting a patient interview, reviewing the patient's lab results, creating or updating a treatment plan, and/or conducting a therapeutic session) and performed during different login sessions, by different providers, and/or at different workstations. Another super-task involving different atomic tasks is the work performed by a particular physician throughout a specified period (the physician and time period being the filtering criteria). Examples of “super-tasks” that include, by contrast, multiple instances of the same type of atomic tasks include the entirety of patient take-in screenings performed in an emergency room during a specified time period, or the processing of all prescriptions received at a pharmacy by a certain cut-off time. An exemplary super-task involving multiple instance of the same or similar sets of atomic tasks is the collection of treatments given at a hospital to patients with similar conditions and symptoms (the conditions or symptoms being the filter). In general, tasks can be defined in any suitable manner by an analyst or other system user (who may, but need not also be a user of applications that are being monitored), as long as the task-defining information is available from the recorded data.

In addition to defining the task(s) of interest, the user may also specify a metric (or multiple metrics) according to which the task is to be analyzed. Such metrics may, for instance, be geared towards measuring the efficiency of task execution, and may include, without limitation, the time elapsed from start to completion of performance of the task, the number of different screens or the number of different applications accessed during performance of the task, the number of screen transitions experienced by the user, the amount of user input provided in performance of the task, the number of different caretakers involved in performance of the task, the number of workstations utilized, the cost incurred in performance of the task, etc. The computed metric may help to identify inefficiencies in the workflow and, more importantly, to predictively quantify the benefits of eliminating or reducing them. For example, statistics on the types of tasks users perform can reveal the steps in the interaction with applications that are amenable to automation. In healthcare, the ability to set the patient context for all EMR applications launched by the clinician, for example, has traditionally been viewed as beneficial but exactly how beneficial has been difficult to quantify. Collected task data showing how long it takes to navigate an application to a specific patient can be used to provide the needed quantification and assess the contribution that eliminating the task would make toward the aggregate cost of patient care. Efficiency improvements based on identified inefficiencies may be achieved in many ways, for example, by modifying applications to eliminate superfluous screens from a workflow, employing context-management strategies to auto-populate forms and auto-import information from other applications and databases (e.g., to eliminate the need for the clinician to manually navigate to the patient in each application), coordinating workflows to avoid duplication of efforts by multiple providers, and streamlining the log-in process (e.g., by using single-sign-on technology to eliminate the need to log separately into different applications, and/or by authenticating users with biometrics or proximity-based devices to obviate the need to enter log-in credentials).

Another, related set of metrics may serve to quantify the work throughput for defined sets of human or other resources, e.g., for the purpose of resource allocation and cost justification; such metrics may include, e.g., the average number patients processed by a particular department per day, or the utilization time of diagnostic and therapeutic apparatus or other devices. Metrics may also serve various audit purposes; for instance, it may be desirable to determine the total amount of radiation therapy, or of a particular medication, that a patient has received over an extended time period, or to monitor the number of people that have accessed the patient's records. Of course, the data need not always be analyzed in accordance with a numerical metric, but may also serve to mine information and/or generate reports of a qualitative nature (e.g., for auditing purposes). The ability to link recorded events with contextually relevant tasks may, in this scenario, provide a powerful tool for obtaining the desired information efficiently, eliminating the need to manually sift through insurmountable amounts of data.

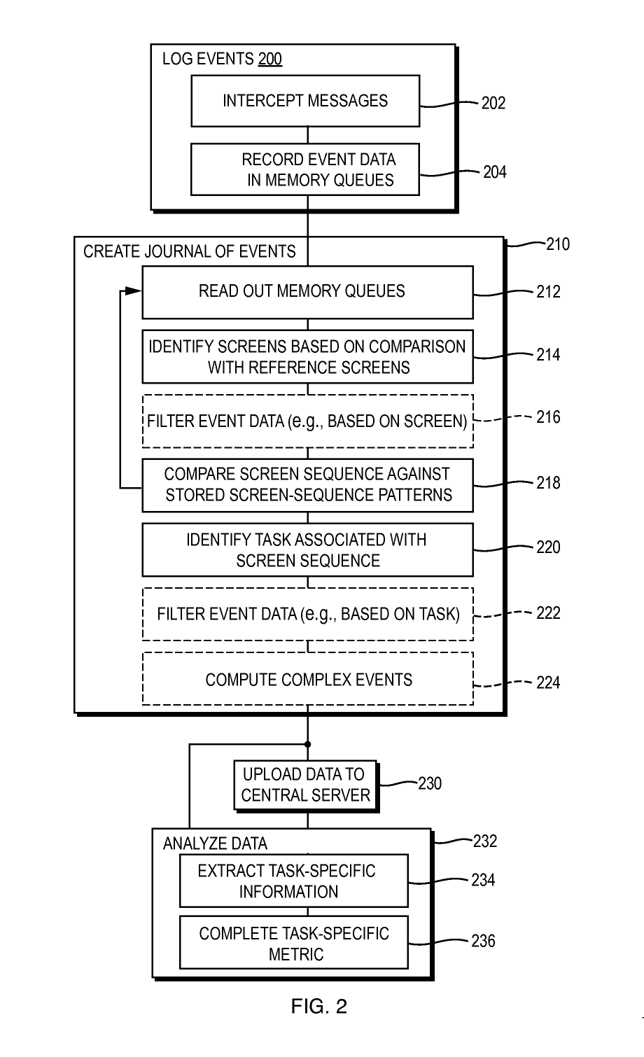

FIG. 2 summarizes methods for monitoring and analyzing computer-application usage in accordance with various embodiments. Application monitoring generally involves logging application-level events (step 200), e.g., by intercepting messages to one or, typically, multiple applications (step 202) and recording data associated with the events, including contents of screens active at the time of the event, in memory (e.g., in temporary memory queues 144) (step 204). During the logging step 200, events may, but need not, be filtered, e.g., based on the event type. From the temporary records of events stored for various monitored applications, a journal of events representing a chronological series of records across the different applications may then be created (step 210). This process may involve reading out the memory queues (step 212), typically asynchronously; comparing the stored screen contents for each event against a set of reference screens to identify the screen (step 214); optionally filtering the events and/or the data associated therewith based on the identified screen (and/or based on other information, such as the type of event) (step 216); comparing sequences of multiple screens (corresponding to sequences of events) against task-specific screen-sequence pattern (step 218), sometimes iteratively for sequences of increasing length, to identify tasks associated with the sequences (step 220); and optionally filtering the events and/or the data associated therewith based on the identified task (step 222) and/or computing complex events from two or more directly observed primitive events (step 224) as discussed above. The journaled data may then be analyzed, either directly on the computer where the information was gathered, or on a separate server (e.g., the analysis server 108 or meta-analysis server 112) to which it may be uploaded (step 230); uploading journal files to a central server facilitates aggregating data across machines (and users) and/or even across institutions. The analysis (step 232) may involve extracting information about one or more (e.g., user-)specified tasks (step 234), and computing a task-specific metric (which may also be specified by a user) based thereon (step 236).

System and methods for task-specific monitoring of computer applications have been described above with reference to a network with a client-server architecture (i.e., including multiple client workstations connected, or connectable, to one or more central servers), as is commonly employed in large institutions such as hospitals. It is to be understood, however, that the principles, techniques, and system components discussed can, with no or little modification, also be implemented in peer-to-peer networks (where the functions otherwise executed on the central server(s) are distributed among the networked machines) or even on individual computing devices. For example, the analysis functions that are, in the described embodiments, performed on a central analysis server, may also be performed, to a large extent, on the computer whose events are being monitored. (Of course, for an isolated computer, such analysis would not be performed on data aggregated over multiple machines.) Conversely, local computational functionality ordinarily implemented on each workstation, such as that of the observer agent 140, may also be implemented remotely (e.g., on a central server or other computer in communication with the computer under observation). Indeed, in some network systems, end-user applications are generally executed on a central application server, with desktop emulation software installed on the individual thin-client workstations providing the necessary interface between the user and the applications; in this case, the observer agent 140 and its hooks 142 into the various applications are more suitably likewise executed on the application server.

Further, while FIG. 1 depicts a particular two-tier network structure in which a central server internal to an institution communicates with local workstations via a local-area network and with the external world via the Internet, this structure can be replaced by other types of networks and relations therebetween , as will be readily apparent to those of skill in the art. The term “network” is herein used broadly to connote wired or wireless networks of computers or telecommunications devices (such as wired or wireless telephones, tablets, etc.). For example, a computer network may be a local area network (LAN) or a wide area network (WAN). When used in a LAN networking environment, computers may be connected to the LAN through a network interface or adapter. When used in a WAN networking environment, computers typically include a modem or other communication mechanism. Modems may be internal or external, and may be connected to the system bus via the user-input interface, or other appropriate mechanism. Networked computers may be connected over the Internet, an Intranet, Extranet, Ethernet, or any other system that provides communications. Some suitable communications protocols include TCP/IP, UDP, or OSI, for example. For wireless communications, communications protocols may include IEEE 802.11x (“Wi-Fi”), Bluetooth, Zigbee, IrDa or other suitable protocol. Furthermore, components of the system may communicate through a combination of wired or wireless paths, and communication may involve both computer and telecommunications networks. For example, a user may establish communication with a server using a “smart phone” via a cellular carrier's network (e.g., authenticating herself to the server by voice recognition over a voice channel); alternatively, she may use the same smart phone to authenticate to the same server via the Internet, using TCP/IP over the carrier's switch network or via Wi-Fi and a computer network connected to the Internet.

As will be readily understood by those of skill in the art, the servers referred to herein generally include one or more processors, one or more digital storage media in communication therewith, and optionally various user input/output devices or other hardware components connected, via one or more buses, to the processor(s) and memory. The processors (including any processors 120 employed in client devices) may be general-purpose processors, but may utilize any of a wide variety of other technologies including special-purpose hardware, a microcomputer, mini-computer, mainframe computer, programmed microprocessor, microcontroller, peripheral integrated circuit element, a CSIC (customer-specific integrated circuit), ASIC (application-specific integrated circuit), a logic circuit, a digital signal processor, a programmable logic device such as an FPGA (field-programmable gate array), PLD (programmable logic device), PLA (programmable logic array), RFID processor, smart chip, or any other device or arrangement of devices that is capable of implementing the steps of the processes of the invention.

The storage media may include removable and/or nonremovable, volatile and/or nonvolatile computer storage media. For example, a hard disk drive may read or write to nonremovable, nonvolatile magnetic media. A magnetic disk drive may read from or writes to a removable, nonvolatile magnetic disk, and an optical disk drive may read from or write to a removable, nonvolatile optical disk such as a CD-ROM or other optical media. Other removable/nonremovable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The storage media are typically connected to the system bus through a removable or non-removable memory interface.

The application-monitoring and analysis functionality performed by the observer agent 140 (including the hooks 142) as well as the analysis programs(s) running on the analysis server (or, alternative, the workstation 100) may be implemented using computer-executable instructions, e.g., organized into program modules, that are executed by a the respective computer processor. Generally, program modules include routines, programs, objects, components, data structures, etc. that perform particular tasks or implement particular abstract data types. Any suitable programming language may be used to implement the observation agent and analysis program(s) without undue experimentation. Illustratively, the programming language used may include assembly language, Ada, APL, Basic, C, C++, C*, COBOL, dBase, Forth, FORTRAN, Java, Modula-2, Pascal, Prolog, Python, REXX, and/or JavaScript, for example. Further, it is not necessary that a single type of instruction or programming language be utilized in conjunction with the operation of the system and method of the invention. Rather, any number of different programming languages may be utilized as is necessary or desirable.

Although the invention has been described herein with respect to specific embodiments and details, various modifications, alternative embodiments, and different combinations of features that still solve the problems addressed by the invention in a similar manner will be readily apparent to a person of skill in the art, and are understood to be within the scope of the invention.

What is claimed is:

1. A computer-implemented method for monitoring usage of one or more user applications executed as one or more running processes on a computational device, the method comprising:
intercepting messages of the one or more user applications corresponding to a sequence of events;
recording data associated with the events, including contents of application screens presented when the events occurred; and
inferring one or more tasks associated with one or more respective subsequences of the events based, at least in part, from corresponding sequences of application screens.

2. The method of claim 1, further comprising filtering the recorded data based at least in part on the identified one or more tasks.

3. The method of claim 2, wherein filtering the recoded data comprises retaining only data associated with events of the one or more subsequences.

4. The method of claim 2, wherein filtering the recorded data comprises receiving an indication of one or more types of data relevant to the identified one or more tasks and retaining, for each event of the one or more subsequences, only data of the relevant types.

5. The method of claim 1, further comprising computing a metric for at least one identified tasks based at least in part on the data associated therewith.

6. The method of claim 5, wherein the metric comprises at least one of a time elapsed from start to completion of performance of the task, a number of screens accessed during performance of the task, a number of screen transitions associated with performance of the task, or a number of different applications accessed during performance of the task.

7. The method of claim 1, wherein inferring the one or more tasks comprises comparing a sequence of application screens associated with the sequence of events against a database of task-specific screen-sequence patterns.

8. The method of claim 7, further comprising recognizing, for each of the events of the sequence of events, an application screen associated therewith based on the recorded application screen contents.

9. The method of claim 8, wherein recognizing the application screens comprises comparing the screen contents recorded for each of the events against a database of reference screens.

10. The method of claim 1, further comprising filtering the recorded data, prior to inferring the one or more tasks, based at least in part on the application screen contents.

11. The method of claim 11, wherein filtering the recorded data comprises comparing the application screen contents against a database of screen elements associated with tasks of interest.

12. The method of claim 1, wherein at least one of the one or more subsequences comprises events associated with a plurality of user applications.

13. The method of claim 1, wherein intercepting messages corresponding to a sequence of events and recording data associated with the events comprises hooking into the message queues of the one or more applications and saving the data in respective memory queues.

14. The method of claim 1, further comprising aggregating the data across multiple applications by asynchronously reading out the memory queues of the multiple applications and storing the data contained therein in a journal file.

15. The method of claim 1, further comprising aggregating the data across multiple computational devices by uploading journal files therefrom to a central server.

16. A system for monitoring usage of one or more user applications, the system comprising:
a computational device comprising
a. a display;
b. an active computer memory; and
c. a processor configured to execute (i) the one or more user applications stored in the active computer memory and (ii) an agent application, wherein execution of the agent application by the processor causes the processor to:
i. intercept messages generated by execution of the user application and corresponding to a sequence of events;
ii. recording data associated with the events, including contents of application screens presented on the display when the events occurred, in the memory; and
iii. inferring one or more tasks associated with one or more respective subsequences of the events based, at least in part, from corresponding sequences of application screens.

17. The system of claim 16, further comprising a database of reference screens, wherein execution of the agent application causes the processor to compare the stored contents of application screens against the reference screens to thereby identify the screens.

18. The system of claim 17, further comprising a database of task-specific screen-sequence patterns, wherein execution of the agent application causes the processor to compare sequences of application screens, following identification thereof, against the task-specific screen-sequence patterns to thereby infer the one or more tasks associated with the sequences of application screens.

19. The system of claim 18, wherein at least one of the database of reference screens and the database of task-specific screen-sequence patterns is stored on a reference server in communication with the computational device.

20. The system of claim 16, further comprising a computational analysis facility configured to compute a metric for at least one identified tasks based at least in part on the data associated therewith.

21. The system of claim 20, wherein the analysis facility comprises a server in communication with the computational device, the server comprising a processor and computer memory, the memory storing instructions which, when executed by the processor, cause the processor to compute the metric.

22. The system of claim 21, wherein the metric comprises at least one of a time elapsed from start to completion of performance of the task, a number of screens accessed during performance of the task, a number of screen transitions associated with performance of the task, or a number of different applications accessed during performance of the task.

23. The system of claim 16, wherein execution of the agent application by the processor causes the processor further to filter the recorded data based at least in part on the identified one or more tasks.

24. The method of claim 16, wherein at least one of the one or more subsequences comprises events associated with a plurality of user applications.

25. The method of claim 16, wherein execution of the agent application causes the processor to intercept the messages corresponding to the events by hooking into the message queues of the one or more applications and saving the data associated with the events in respective memory queues.

26. The method of claim 25, wherein execution of the agent application further causes the processor to aggregate the data across multiple applications by asynchronously reading out the memory queues of the multiple applications and storing the data contained therein in a journal file in the memory.

27. The method of claim 26, further comprising a central server, wherein execution of the agent application further causes the processor to upload the journal file to the central server for aggregation of data across computational devices thereat.
